(19) United States
(12) Patent Application Publication
(10) Pub. No.: US 2004/0226976 A1
(43) Pub. Date: Nov. 18, 2004

(54) Combustion energy-operated setting tool

(76) Inventors: Kaveh Towfighi, Sigmarszell (DE); Lothar Voelker, Sax (CH)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/780,985

(22) Filed: Feb. 18, 2004

(30) Foreign Application Priority Data
Feb. 19, 2003 (DE) 103 06 880.5

(51) Int. Cl. B25C 1/14

(52) U.S. Cl. 227/10

(57) ABSTRACT

A combustion energy-operated setting tool for driving in fastening elements includes a setting piston (13) displaceable in a guide chamber (11) by reaction gases of a fuel, a bolt guide (20) for receiving and guiding the fastening elements and adjoining the guide chamber (11) in a setting direction, with the bolt guide (20) having a first region (21) with an inner diameter (D1) and a second region (21), extending in a direction toward an end (24) of the bolt guide (20) remote from the guide chamber (11), and having an inner diameter (D2) smaller than the inner diameter (D1) of the first region (21).

### BACKGROUND OF THE INVENTION

1. Field of the Invention

The present invention relates to a combustion energy-operated setting tool including a guide chamber, a setting piston displaceable in the guide chamber by reaction gases of fuel and having a piston stem, and a bolt guide for receiving and guiding the fastening elements and adjoining the guide chamber in the setting direction.

2. Description of the Prior Art

In combustion energy-operated setting tools and, in particular, gas-operated setting tools an example of which is disclosed in German Publication DE 31 51 661 A1, there is provided a piston holder which directly engages the drive piston or directly acts thereon and which serves for stopping the piston. The piston holder holds the piston in its position at the start of combustion in the combustion chamber of the setting tool so that the piston can be driven with a sufficiently high energy in the main phase of the combustion by the expandable combustion gases. This principle is similar to that used in commercial aircrafts in which their turbines are brought to full power before brakes are released in order to be able to move from their stand-position with full power.

The known holding or stopping device, which includes a ball acting on the piston stem, have a serious drawback that consists in that the device acts as a brake during displacement of the piston, which prevents the piston from a complete return to its initial position. During a following setting process, as a result of incomplete return of the piston, the setting energy acting thereon is noticeably reduced, resulting in a faulty process.

Accordingly, an object of the present invention ins a setting tool of the type discussed above in which the drawback of the setting tools with a conventional piston holder is eliminated.

### SUMMARY OF THE INVENTION

This and other objects of the present invention, which will become apparent hereinafter, are achieved by providing a bolt guide having a first region with an inner diameter, and a second region adjoining the first region and extending in a direction toward an end of the bolt guide remote from the guide chamber, with the second region having an inner diameter smaller than the inner diameter of the first region.

By reducing the cross-section of the bolt guide opening, during the setting process, a fastening element, which is displaced in the bolt guide and is provided on its stem with a plastic disc or washer that guides the fastening element, will be braked in the region of the reduced cross-section due to high frictional forces acting on the guide element and to the deformation of the guide element. This deceleration of the displacement of the fastening element also slows the piston for a certain time interval. Therefore, in the first phase of combustion in the combustion chamber, a sufficiently high energy can be built-up for a subsequent driving of the piston in the setting direction with a complete power. When the piston returns to its initial position, the stop means according to the present invention does not interfere with the return movement of the piston as they act on the piston indirectly, through the fastening element.

It is advantageous, when the inner diameter of the first region is greater than an outer diameter of an at least partially elastic, guide element provided on a fastening element and formed, e.g., as a guide disc of a plastic material, and the inner diameter of the second region is smaller than the outer diameter of the guide element but greater than the outer diameter of the piston stem.

The foregoing features insure an error-free, in particular, without tilting of the fasting element, functioning of the setting tool, with the piston slowing in the early phase of the combustion phase.

For cost-effective manufacturing of the inventive setting tool, the second, reduced diameter region can extend up to the end of the bolt guide facing in the setting direction.

According to a further advantageous embodiment of the present invention, a third region, which has an inner diameter substantially equal to that of the first region, adjoins the second region. In order to enable a friction-free transition of a fastening element and the guide element from one region in another region of the bolt guide, between the regions, inclined surfaces having different inner diameters can be provided.

A reliable stoppage of the piston is achieved when the inner diameter of the second region is smaller than the outer diameter of the guide element, which is used with the fastening element, by from 0.5 mm to 0.5 mm.

According to a still further advantageous embodiment of the present invention, within the second region, there are provided elements movable in and out of the bolt guide. Preferably, the penetration depth of the elements in the bolt guide is steplessly controlled. This feature permits to drive, with the setting tool, fastening elements and guide elements, which are arranged thereon, having different diameters. Thus, the piston slowing can be adjusted by adjusting the cross-section of the opening in the second region.

For automatic displacement of the elements out of the bolt guide, spring means can be provided between the elements and the bolt guide and which biases the elements in the direction in which they displace out of the bolt guide.

According to a preferred embodiment of the invention, the elements can be steplessly displaced in the bolt guide with an adjusting member formed, e.g., as a knurled screw. Upon release of the knurled screw, the elements can be pressed out of the bolt guide by the biasing force of the spring means.

The novel features of the present invention, which are considered as characteristics for the invention, are set forth in the appended claims. The invention itself, however both as to its construction and its mode operation, together with additional advantages and objects thereof, will be best understood from the following detailed description of preferred embodiments, when read with reference to the accompanying drawings.

### BRIEF DESCRIPTION OF THE DRAWING

The drawing show:

FIG. 1 a side, partially cross-sectional view of a setting tool according to the present invention with a fastening element located in the bolt guide;

FIG. 2 a cross-sectional view of the bolt guide of the setting tool shown in FIG. 1 with the fastening element in an initial position (shown with dash line) and a first intermediate position (solid lines);

FIG. 3 a cross-sectional view of the bolt guide shown in FIG. 2 with the fastening element in the second intermediate position;

FIG. 4 a cross-sectional view of another embodiment of a bolt guide with a fastening element in the intermediate position;

FIG. 5 a cross-sectional view of a further embodiment of the bolt guide with an adjustable reduction of the inner diameter in its first position with a fastening element in the initial position; and

FIG. 6 a cross-sectional view of the bolt guide shown in FIG. 5 with the fastening element in the second position.

### DETAILED DESCRIPTION OF THE PREFERRED EMBODIMENTS

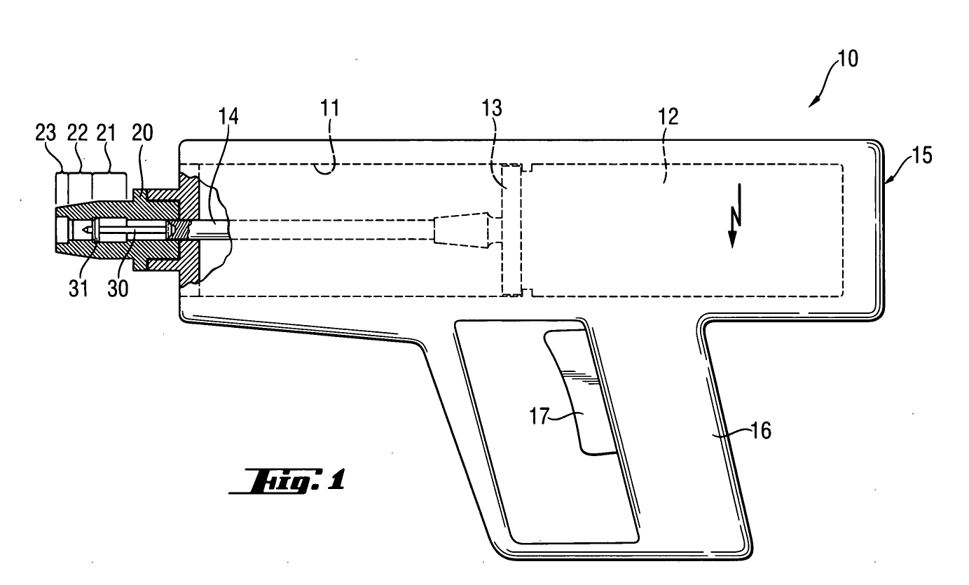

As discussed above, FIG. 1 shows a side, partially cross-sectional view of a gaseous fuel-driven setting tool 10 according to the present invention. The setting tool 10 has a one-or multi-piece housing 15 with a handle 16 provided with an actuation switch 17 with which a setting process can be initiated. In the housing 15, there is provided a combustion chamber 12 in which an air-fuel mixture can be ignited with an ignition device (not shown). A setting piston 13 with a piston stem 14 is axially displaceable in a guide chamber 11 that adjoins the combustion chamber 12. The guide chamber 11 opens into a bolt guide 20 arranged at the front of the setting tool 10. In the bolt guide 20, there are arranged fastening elements 30, which are driven by a free end of the piston stem 14, upon actuation of the setting process, in a constructional component (not shown). For guiding the fastening elements 30 in the bolt guide 20, they are provided with guide elements 31 such as, e.g., disc-shaped elements.

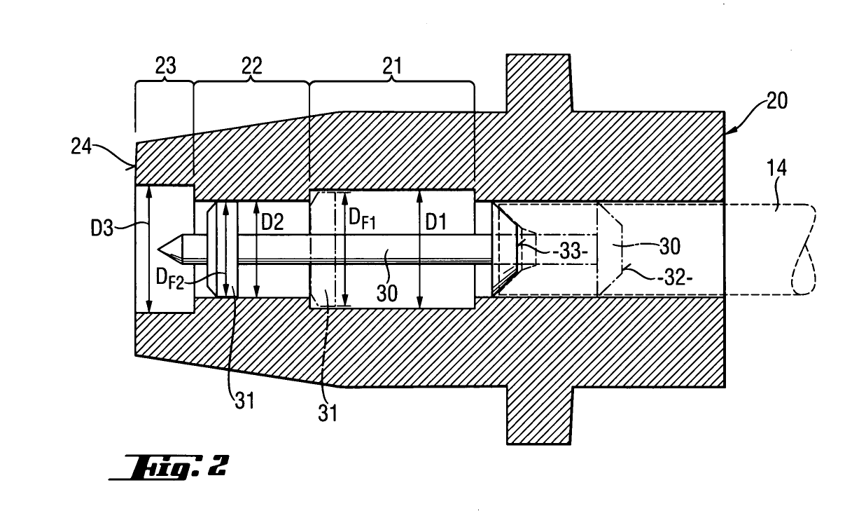

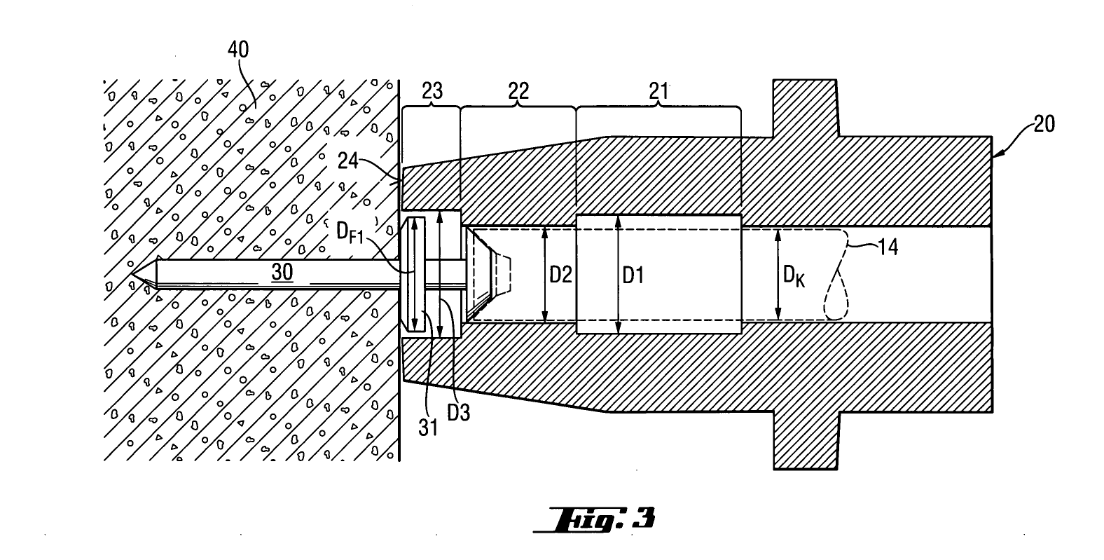

The bolt guide 20 is shown in detail in FIGS. 2-3. As shown in FIGS. 2-3, the bolt guide 20 has a first region 21 which is provided, in the embodiment of the bolt guide 20 shown in the drawings, somewhat in the middle of the bolt guide 20. In the direction of the front end 24 of the bolt guide 20, a second region 22 adjoins the first region 21. The inner diameter D1 of the first region 21 is larger than the inner diameter D2 of the second region 22. Between the front end 24 of the bolt guide 20 and the second region 22, there is provided a third region 23 of the bolt guide 20 the inner diameter D3 of which substantially corresponds to the inner diameter D1 of the first region 21. In the bolt guide 20 shown in FIG. 2, a fastening element 30 is shown in its initial position 32 (with dash-dot lines). The guide element 31 of the fastening element 30, e.g., a plastic disc-shaped element, is located in the first region 21 of the bolt guide 20. The fastening element 30 can be manually inserted in the bolt guide 20, e.g., through a side opening or be inserted from a magazine (not shown) with fastening elements that can be attached to the bolt guide 20. As shown in FIG. 2 the outer diameter D_{F1} of the guide element 31 is larger than the inner diameter D2 of the second region 22 of the bolt guide 20 but is somewhat smaller, within a backlash, than the inner diameter D1 of the first region 21 of the bolt guide 20 in which the guide element 31 is located. When the fastening element 30 is driven by the piston stem 14 of the piston 13 (not shown in FIG. 2) forward, the guide element 31 should pass the reduced diameter region 22 of the bolt guide 20. Upon passing, the outer diameter of the guide element 31 is reduced to a diameter D_{F2}, as shown in intermediate position 33 of the fastening element 30. The reduction of the outer diameter of the guide element 31 by the narrower region 22 leads to slowing of the setting piston 13 which, in turn, leads to generation of high setting energy in the combustion chamber 12 as a result of a progressive combustion of the fuel therein. The high setting energy insures a complete setting of the fastening element 30.

FIG. 3 shows the bolt guide 20 being set against a constructional component 40, with the fastening element 30 being partially driven in the constructional component 40. As can be seen in FIG. 3, the guide element 31 has already passed the second region 22 of the bolt guide 20 and has its initial diameter D_{F1} restored. The fastening element 30 can be completely driven in the constructional component by the piston stem 14 of the setting piston 13 only with the use of all of the generated setting energy.

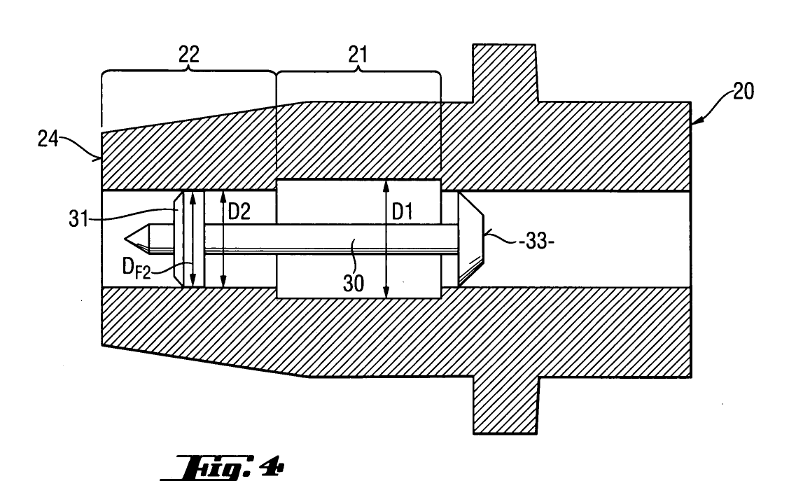

A further embodiment of the bolt guide 20 is shown in FIG. 4. The bolt guide 20 shown in FIG. 4 differs from that shown in FIGS. 2-3 in that the second region 22 extend to the front end 24 of the bolt guide 20. In all other respects, reference is made to the description of the bolt guide 20 and the fastening element 30 shown in FIGS. 1-3.

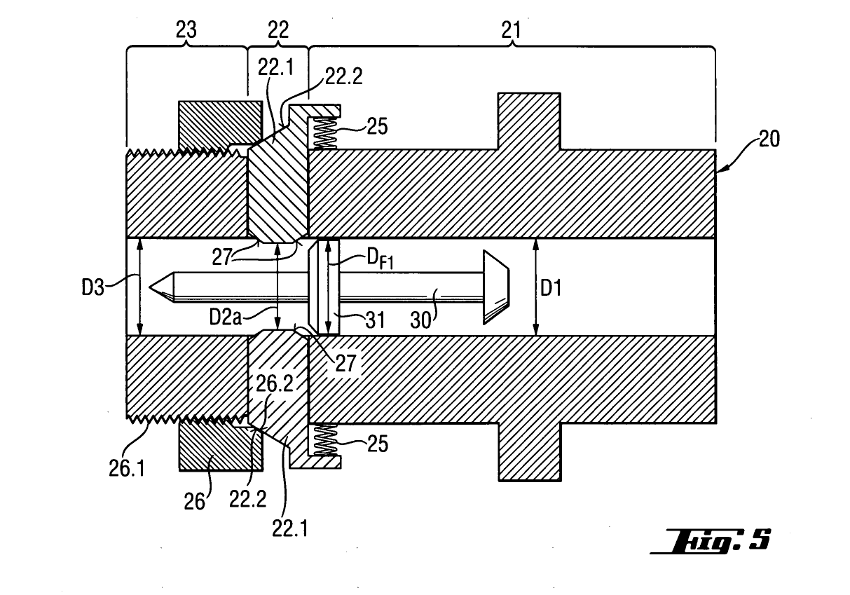

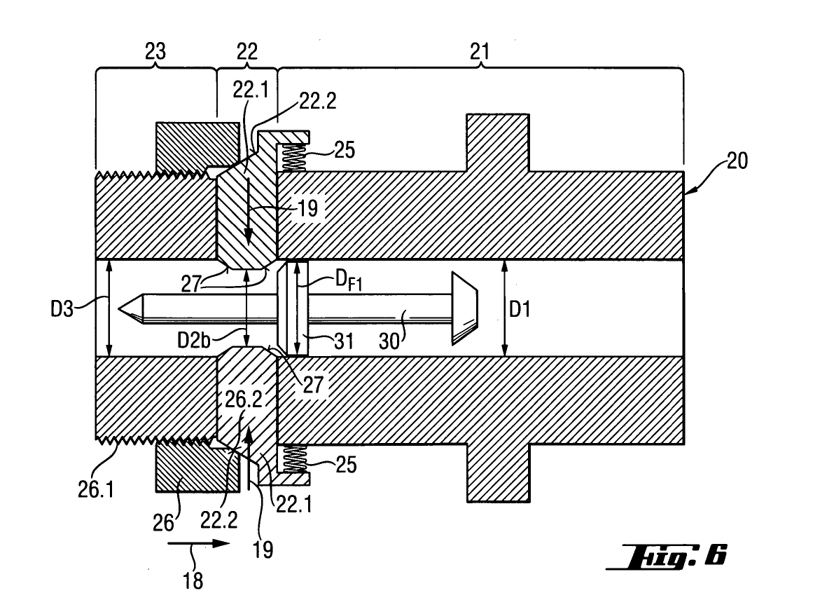

A still further embodiment of the bolt guide 20 is shown in FIGS. 5-6. The bolt guide 20, which is shown in FIGS. 5-6 differs from that shown in FIGS. 1-3 in that displaceable elements 22.1, which can be drawn in or pulled out of the bolt guide 20, are provided in the second region of the bolt guide 20. The displaceable elements 22.1 are supported in the bolt guide 20 by springs 25. The springs 25 preload the displaceable elements 22.1 in their pull-out direction. The ends of the displaceable elements 22.1, which project from the bolt guide 20 are provided with control surfaces 22.2. And adjusting member 26, which is formed, in the embodiment shown in FIGS. 5-6 as a knurled screw, serves for adjusting the position of the elements 22.1 and has control surfaces 26.2 that cooperate with control surfaces 22.2 of the displaceable elements 22.1. In the embodiment shown in FIGS. 5-6, the control surfaces 22.2 and 26.2 are formed as inclined surfaces. The knurled screw, the adjusting member 26, is displaced along a thread 26.1 provided on the bolt guide. Upon rotation of the adjusting member 26 clockwise, the adjusting member 26 is displaced in the direction of arrow 18, applying pressure, with the control surfaces 26.2, to opposite control surfaces 22.2 of the elements 22.1. As a result, the elements 22.1 are displaced against the biasing forces of the springs 25 in the direction of arrow 19 in the interior of the bolt guide, as shown in FIG. 6. When the adjusting member 26 is rotated in the counter-clockwise direction, the elements 22.1 are displaced, as a result of application of the biasing force of springs 25 thereto, out of the bolt guide 20.

In order to prevent tilting of the guide element 31 when the fastening element 30 passes the region 22, an inclined surfaces 27 are provided on the edge regions of the elements 22.1. The inclined surfaces 27 facilitate entry of the guide elements 31 in the reduced diameter region 22 of the bolt guide 20. Other elements of the bolt guide 20 and the fastening element 30 are the same as those of the bolt guides 20 shown in FIGS. 1-4.

Though the present invention was shown and descried with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. A combustion energy-operated setting tool for driving a fastening elements, comprising:
a guide chamber (11);
a setting piston (13) displaceable in the guide chamber (11) by reaction gases of a fuel and having a piston stem (14); and
a bolt guide (20) for receiving and guiding the fastening elements and adjoining the guide chamber (11) in a setting direction, the bolt guide (20) having a first region (21) with an inner diameter (D1), and a second region (22) adjoining the first region (21) and extending the first region (21) and extending in a direction toward an end (24) of the bolt guide (20) remote from the guide chamber (11), the second region (22) having an inner diameter (D2) smaller than the inner diameter (D1) of the first region (21).

2. A setting tool according to claim 2, wherein the inner diameter (D1) of the first region (21) is greater than an outer diameter (D_{K}) of the piston stem (14) and greater than an outer diameter (D_{F1}) of an at least partially elastic, guide element (31) provided on a fastening element (30), and
wherein the inner diameter (D2) of the second region (22) is smaller than the outer diameter (D_{F1}) of the guide element (31) but greater than the outer diameter (D_{K}) of the piston stem (14).

3. A setting tool according to claim 1, wherein the second region (22) extends up to the remote end (24) of the bolt guide (30).

4. A setting tool according to claim 1, wherein the bolt guide has a third region (23) adjoining the second region (22) and having an inner diameter (D3) greater than the inner diameter (D2) of the second region (22).

5. A setting tool according to claim 4, wherein the inner diameter (D3) of the third region (23) corresponds to the inner diameter (D1) of the first region.

6. A setting tool according to claim 4, wherein transition regions between the first and second regions (21, 22) and between the second and third regions (22, 23) are formed each as an inclined surface (27).

7. A setting tool according to claim 2, wherein the inner diameter of the second region (22) is smaller than the outer diameter (D_{F1}) of the guide element (31) of the fastening element (30) by from 05 mm to 0.5 mm.

8. A setting tool according to claim 1, wherein the second region (22) is formed by at least one member (22.1) displaceable in the bolt guide (20).

9. A setting tool according to claim 8, further comprising a spring member (25) for biasing the at least one displaceable member (22.1) in a direction out of the bolt guide (20).

10. A setting tool according to claim 9, further comprising an adjusting member (26) for displacing the at least one displaceable member (22.1) into the bolt guide (20).

11. A setting tool according to claim 10, wherein the adjusting member (26) is formed as a knurled screw.
